(19) United States
(12) Patent Application Publication
(10) Pub. No.: US 2003/0010237 A1
(43) Pub. Date: Jan. 16, 2003

(54) Pump inking unit

(76) Inventor: Wolfgang Peter Zink, Obertheres (DE)

Correspondence Address: Douglas R Hanscom, Jones Tullar & Cooper, Eads Station, PO Box 2266, Arlington, VA, 22202, US

(21) Appl. No.: 10/181,946

(22) PCT Filed: Dec. 12, 2000
(86) PCT No.: PCT/DE00/04427

(30) Foreign Application Priority Data
Feb. 10, 2000 (DE) 100 05 876.0

(51) Int. Cl. B41F 31/02

(52) U.S. Cl. 101/366

(57) ABSTRACT

The invention relates to an ink pump (14) for a pump inking unit (1) of a rotary printing press. A two-piece coupling is provided between a pump drive (23) which is situated in a traversing component and a transportable ink discharge unit (3) which is situated on the traversing component. Each piece of the coupling consists of a permanent magnet (28, 33) which is connected to the pump drive or the ink pump respectively. The permanent magnets engage in a non-positive fit. A robust coupling is thus provided.

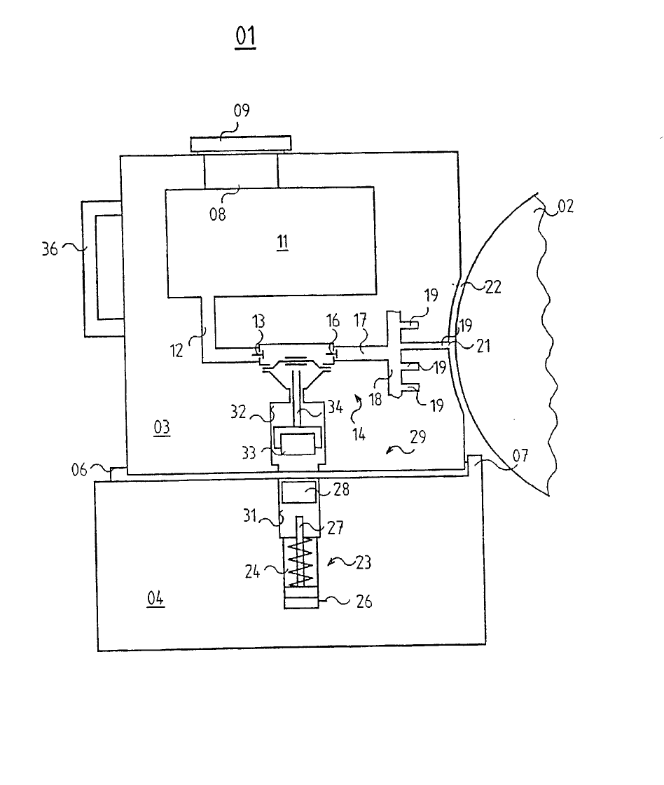

The invention relates to a pump inking unit according to the preamble to claim 1.

DE 91 00 535 U1 has disclosed a pump unit for supplying fluid substances to a printing or coating machine, in which a component unit, which can be removed in one piece, is at least comprised of a pump, a pump drive unit, and a reservoir.

DE 38 32 183 C1 has disclosed a pump unit with a replaceable ink fountain and a pump. A pump drive unit and the pump can be coupled by means of an electromagnetic clutch.

The object of the invention is to provide an ink pump for a pump inking unit of a rotary printing press.

The object is attained according to the invention by means of the characteristics of claim 1.

The advantages that can be achieved with the invention are comprised particularly in the fact that the replaceable ink fountain of the pump inking unit is only associated with the components, which are absolutely required for the inking. For this reason, at least the drive unit for the ink pump is disposed in the cross bar that is fastened to the lateral racks.

The clutch between the drive unit disposed in the cross bar and the ink pump disposed in the ink fountain is ruggedly designed so that contaminations due to ink and the like cannot impair the force transmission of the pump drive unit.

An exemplary embodiment of the invention is shown in the drawing and will be described in detail below. The sole figure schematically depicts a cross section through a pump inking unit with a traveling inking unit, which is a fraction of the width of the paper web and is disposed on a cross bar fastened to the lateral racks.

A pump inking unit 01 is comprised of one or more, preferably four, traveling inking units 03 disposed next to one another in a direction axially parallel to an inking roller 02 the width of the printing press. The inking units 03 are disposed on a cross bar 04 extending in an axially parallel direction between the lateral racks and are supported so that they can slide in the radial direction of the inking roller 02. The inking units 03 are respectively disposed on profiled rails 06, which extend on the cross bar 04, lateral to its longitudinal axis. At their ends oriented toward the inking roller, the profiled rails 06 affixed to the cross bar 04 have a stop 07 to limit the insertion movement of the inking unit 03 as well as means, not shown, for locking the inserted inking unit 03 in place.

Each replaceable or traveling inking unit 03 has an ink reservoir 11 that can be filled by means of an opening 08 and can be closed by means of a cover 09.

By means of a discharge line 12 and a check valve 13, the ink reservoir 11 is connected to the inlet of an ink pump disposed in the inking unit 03, for example a diaphragm pump 14. The outlet of the diaphragm pump 14 in turn is connected to a distributor line 18 by means of a check valve 16 and a supply line 17.

By contrast with the position shown in the drawing, the distributor line 18 extends axially parallel to the inking roller 02 and has a number of three to ten, preferably five, outlet lines 19 spaced apart from one another, each for a quarter-width inking unit 03. The outlet lines 19 extend parallel to one another in the radial direction and each feed via an outlet opening 21 into an arc-shaped annular gap 22, which the inking roller 02 passes through with its circumferential surface.

A pump drive unit 23 is disposed in the cross bar 04 and is comprised, for example, of a pneumatically actuated working cylinder 24, which is supplied at intervals with compressed air by means of a supply fitting 26. At its end remote from the working cylinder 24, the piston rod 27 disposed in the cylinder has a two-part clutch 29, which can be moved back and forth in a vertically extending guide, e.g. a bore 31, of the cross bar 04 during operation, i.e. it executes an oscillating motion. The bore 31 is disposed directly opposite a guide or bore disposed in the replaceable inking unit 03 so that the two bores 31; 32 are flush with each other.

A second permanent magnet 33, which is polarized in opposition to the first permanent magnet 28, is disposed in the bore 32 and is affixed to the end of the piston rod 34 of the diaphragm pump 14 remote from the diaphragm.

It is naturally also possible to use a double-action working cylinder, a crank mechanism, or a so-called sliding block mechanism as a pump drive unit 23.

The pump inking unit 01 functions as follows:

After the ink reservoir 11 is filled with printing ink, the inking unit 03, for example by means of handles 36, is placed onto the profiled rails 06, slid against the stop 07, and locked in place. By actuating the pump drive unit 23, the permanent magnets 28; 33 are connected to each other in a frictionally engaging manner and the diaphragm pump 14 sends the printing ink into the distributor line 18 and consequently into the outlet lines 19 and via the outlet openings 21 into the annular gap 22, and onto the circumference surface of the inking roller 02.

A metering valve can also be provided for each outlet opening 21.

### Reference Numeral List

| | |
|---|---|
| 01 | pump inking unit |
| 02 | inking roller (01) |
| 03 | inking unit (01) |
| 04 | cross bar (01) |
| 05 | — |
| 06 | profiled rails |
| 07 | stop (06) |
| 08 | opening (11) |
| 09 | cover (03) |
| 10 | — |
| 11 | ink reservoir (03) |
| 12 | discharge line (11) |
| 13 | check valve (12) |
| 14 | diaphragm pump, ink pump (12; 17) |
| 15 | — |
| 16 | check valve (17) |
| 17 | supply line |
| 18 | distributor line |
| 19 | outlet line |
| 20 | — |
| 21 | outlet opening (19) |
| 22 | annular gap (03) |
| 23 | pump drive unit (04) |
| 24 | working cylinder (23) |
| 25 | — |
| 26 | supply fitting (24) |
| 27 | piston rod (24) |
| 28 | first permanent magnet (27) |
| 29 | two-part clutch |
| 30 | — |
| 31 | bore (04) |
| 32 | bore (03) |
| 33 | second permanent magnet |
| 34 | piston rod (14) |
| 35 | — |
| 36 | handle (03) |

1. A pump inking unit (01) of a rotary printing press, with one or more replaceable inking units (03), each having at least a reservoir (11); a pump drive unit (23) and a first clutch part (28) connected to the pump drive unit (23) are provided and each inking unit (03) has an ink pump (14) and a second clutch part (33) connected to the ink pump (14), characterized in that the first and second clutch parts (28; 33) execute a linear, oscillating motion during operation.

2. The pump inking unit (01) according to claim 1, characterized in that the first and second clutch parts (28; 33) are embodied as a magnetic clutch (28; 33).

3. The pump inking unit (01) according to claim 2, characterized in that each clutch part (28; 33) has a permanent magnet (28; 33).

4. The pump inking unit (01) according to claim 1, characterized in that the ink pump (14) is embodied as a diaphragm pump.

5. The pump inking unit (01) according to claim 1, characterized in that the pump drive unit (23) is comprised of a working cylinder (24).

6. The pump inking unit (01) according to claim 1, characterized in that the pump drive unit (23) is comprised of a crank mechanism.

7. The pump inking unit (01) according to claim 1, characterized in that the pump drive unit (23) is comprised of a sliding block mechanism.

8. The pump inking unit (01) according to claim 1, characterized in that a number of outlet openings (21) are provided in each inking unit (03).

9. The pump inking unit (01) according to claim 8, characterized in that each outlet opening (21) is associated with a metering valve.

10. The pump inking unit (01) according to claim 1, characterized in that a cross bar (04) is provided between the lateral racks of the rotary printing press and the pump drive unit (23) is disposed in the cross bar (04).
